(19) United States
(12) Patent Application Publication
(10) Pub. No.: US 2022/0240717 A1
(43) Pub. Date: Aug. 4, 2022

(54) RADIATION GRILL WITH ROASTING DRUM

(71) Applicant: Kammerer GmbH, Remchingen (DE)

(72) Inventor: Rolf Kammerer, Remchingen (DE)

(73) Assignee: Kammerer GmbH, Remchingen (DE)

(21) Appl. No.: 17/660,574

(22) Filed: Apr. 25, 2022

Related U.S. Application Data
(63) Continuation of application No. PCT/EP2020/079369, filed on Oct. 19, 2020.

(30) Foreign Application Priority Data
Nov. 13, 2019 (DE) 10 2019 30 631.0

(51) Int. Cl. A47J 37/06; A47J 37/04

(52) U.S. Cl. CPC A47J 37/0635; A47J 37/047

(57) ABSTRACT

A radiation grill includes a housing, radiators, which are arranged in the housing, a roasting drum for receiving roast product, which may be rotatably arranged in the housing between the radiators, and a drive in order to set the roasting drum into rotation. A temperature sensor is configured for measuring the temperature of roast product in the roasting drum.

### CROSS-REFERENCE TO RELATED APPLICATIONS

This continuation application claims priority to PCT/EP2020/079369 filed on Oct. 19, 2020 which has published as WO 2021/094060 A1 and also the German application number 10 2019 130 631.0 filed on Nov. 13, 2019, the entire contents of which are fully incorporated herein with these references.

### DESCRIPTION

### Field of the Invention

The invention relates to a radiation grill comprising a roasting drum.

### Background of the Invention

A radiation grill with the characteristics mentioned in the preamble of claim 1 is known from DE 10 2017 106 953 A1.

A radiation grill includes a housing, in which several radiators are arranged, with which product to be grilled such as meat, fish or vegetables are irradiated from two opposing sides and thus cooked. It is known from DE 10 2017 106 953 A1 to provide a radiation grill with a roasting drum, in which coffee beans and the like are roasted. Turning the roasting drum causes its content to be continuously intermixed, so that coffee beans or the like contained in the roasting drum are roasted evenly and within a very short time.

### SUMMARY OF THE INVENTION

It is an aim of the present invention to provide a radiation grill with a roasting drum, which enables an even better result to be obtained when roasting coffee beans or the like.

This aim is achieved by a radiation grill according to claim 1. Advantageous refinements of the invention are the matter of dependent claims.

A radiation grill according to the invention includes a temperature sensor in order to measure the temperature of product being roasted in the roasting drum. Knowing the temperature of the product being roasted makes it possible to control irradiation of the product in such a way as to achieve an optimum roasting result with best possible flavour.

A radiation grill according to the invention may contain a memory with control and regulating instructions for the halogen radiators in order to determine time periods during which product being roasted is to be maintained at a specified temperature. It is thus possible to store recipes for the preparation of product to be roasted, in particular coffee beans. Various recipes for a product to be roasted such as coffee beans may be stored in order to achieve different flavours by means of different roasting times or roasting temperatures.

Such a memory considerably facilitates work. Preparation of roast product involves placing the same into the radiation grill and then choosing a corresponding recipe from the memory, i.e., a sequence of appropriate instructions for closed or open loop control. The radiation grill can thus prepare roast product without any further human intervention. Corresponding recipe data bases may be provided by the manufacturer in the memory, from which a user or chef then makes a suitable selection. The selection of recipes or series of control commands may be performed using the controls on the grill, e.g., a touchscreen (also called sensor screen). Alternatively or additionally such a selection may also be made wirelessly, for example by means of a mobile telephone and a WLAN or Bluetooth interface of the radiation grill.

Preferably the roasting drum includes two glass plates, which are connected with each other via a circumferential wall. Coffee beans and other roast product in the internal space of the roasting drum can thus be irradiated by the radiators of the radiation grill, for example halogen radiators, and thereby be roasted.

An advantageous refinement of the invention provides for the roasting drum to include one or more openings in a circumferential wall for taking temperature measurements. In this way it can be largely avoided that temperature measurements are impaired by the radiation emitted by the radiators.

For temperature measurements an infrared sensor may be provided, which registers infrared radiation that is emitted by the roast product and exits through the one or more openings in the circumferential wall of the roasting drum. Advantageous infrared sensors are, in particular, sensors, which have a minimum size opening angle and thus considerably reduce interference factors, for example infrared sensors with an opening angle of 15° or less.

Alternatively or additionally a temperature sensor for taking temperature measurements may be a sensor such as a thermos couple, which projects into the roasting drum through an opening extending circumferentially in the circumferential wall. The opening may be designed as a slot.

The width of the slot or the size of the openings in the circumferential wall is dimensioned such that coffee beans or similar roast product cannot drop out of the roasting drum. It is convenient for example, if the openings have a width in the range from 1.0 to 3.0 mm.

### BRIEF DESCRIPTION OF THE DRAWINGS

Further details and advantages of the invention are being explained by way of illustrative embodiments with reference to the attached drawings. Identical or mutually corresponding components have been marked in there with matching reference numbers. In the drawings:

FIG. 1 shows an embodiment of a radiation grill with a roasting drum;

FIG. 2 shows a sectional view of the radiation grill;

FIG. 3 shows a schematic representation of an embodiment of a roasting drum;

FIG. 4 shows a schematic representation of a cut-out of the roasting drum shown in FIG. 3 with coffee beans and temperature sensor;

FIG. 5 shows a schematic representation of a further embodiment of a roasting drum;

FIG. 6 shows a schematic representation of a cut-out of the roasting drum shown in FIG. 5 with coffee beans and temperature sensor;

FIG. 7 shows a further embodiment of a radiation grill with a roasting drum; and

FIG. 8 shows a side view of FIG. 7.

### DETAILED DESCRIPTION OF THE PREFERRED EMBODIMENTS

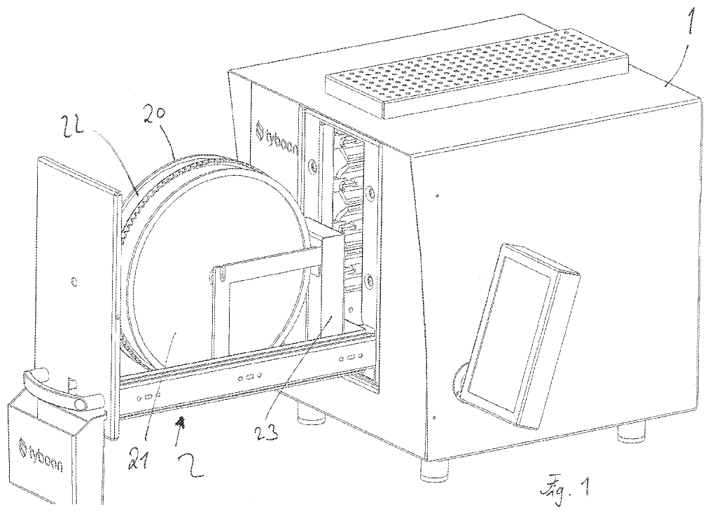

The radiation grill shown in FIG. 1 comprises a housing 1 and a pull-out 2, which in FIG. 1 is shown in its pulled-out position, and in its pushed-in position closes an opening in a front side of the housing 1. The pull-out 2 supports a roasting drum 20, which includes two side walls 21 connected via a circumferential wall 22 and made of glass, preferably glass plates. The roasting drum 20 is rotatably held by a mounting 23, which is supported by the pull-out 2, for example in that pins or an axis in the centre of the drum lie in slots of the mounting 23. By rotating the roasting drum 20 roast product such as coffee beans deposited in the drum is intermixed, so that it is evenly irradiated from all sides.

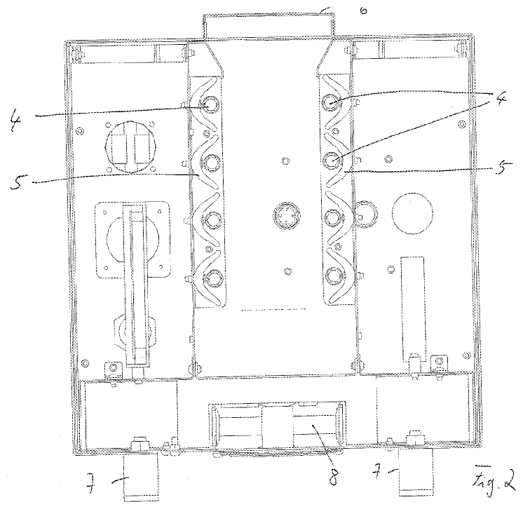

When the pull-out 2 is pushed into the housing 1, the roasting drum 20 is positioned between two groups of radiators 4 arranged in the housing 1, which in particular are to be seen in FIG. 2.

The roasting drum 20 may contain mixing elements. When the roasting drum 20 is rotating, mixing elements can ensure more thorough mixing of the roast product such as coffee beans held in the drum, so that the same is evenly irradiated from all sides.

In order to set the roasting drum 20 into rotation, this may include a sprocket on its circumferential wall 22. This enables an electric motor, which is arranged in the housing of the radiation grill, to exert a torque onto the sprocket via a gear wheel.

FIG. 2 shows a sectional view of FIG. 1, the section line of which extends vertically to the direction of movement of the pull-out 2 through the housing 1, which on its topside carries a grid or perforated plate 6 with venting openings and on its underside has feet 7. The radiators 4 may for example be halogen radiators, for example in the form of rods. The radiators 4 may for example have halogen radiators associated with them, which are concavely curved. The reflectors 5, which are preferably made of ceramics such as aluminium oxide, improve utilization of the light generated by the radiators 4. Moreover, when viewed from the side of the radiators, temperature-sensitive components of the radiation grill, for example control electronics, may be arranged behind the reflectors 5. The reflectors 5 may be designed as individual shells, for example in the form of gutters. The reflectors 5 may be fastened individually to an inner wall, for example by means of screws and nuts.

Cooling may be effected by arranging a fan 8 or a plurality of fans in the housing 1. The fan 8 generates a cooling air current through the cooking space, for example from venting openings on the underside of the housing 1 to the grid or perforated plate 6 on the topside of the housing 1.

The maximum pull-out path of the pull-out 2 is limited by a stop. The pull-out 2 may be fastened to the housing by means of a telescopic rail guide. Use may be made of ball-bearing guides, in order to reduce the force for moving the pull-out 2. Suitable telescopic rail guides are for example known from EP 1 540 253 B1 as well as EP 0 952 403 A2. In case of telescopic rail guides a stop for limiting the maximum pull-out path may be provided in that an outer rail, for example a metal profile, includes a journal or a pin at its end, against which the inner rail abuts. Another possibility consists in closing off the ends of the outer rails. The inner rail can then move in the outer rail only as far as the closed-off end, where it is then stopped.

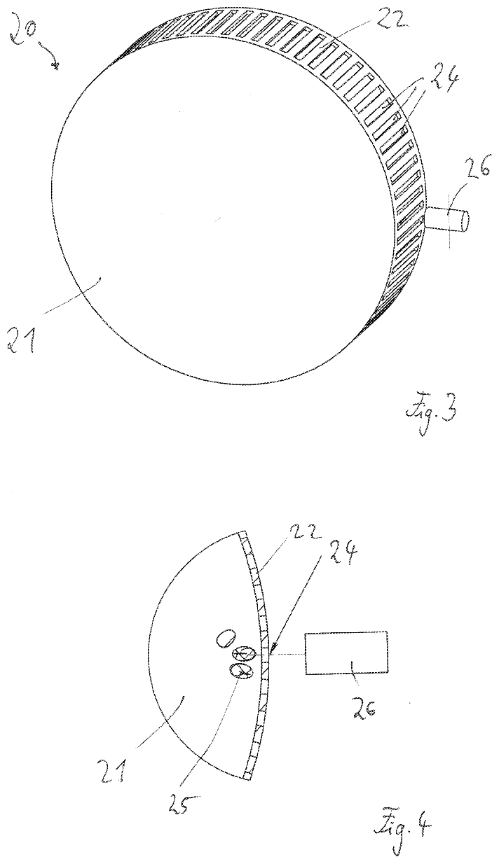

FIGS. 3 and 4 show a schematically drawn embodiment of the roasting drum 20. The circumferential wall 22 of the roasting drum 20 has openings 24 for taking temperature measurements. The temperature of coffee beans 25 or other roast product contained in the roasting drum 20 is registered by a temperature sensor 26. With the embodiment shown this temperature sensor 26 is an infrared sensor, which registers infrared radiation of roast product exiting through the openings 24. The size of the openings 24 is dimensioned such that coffee beans cannot escape through the openings.

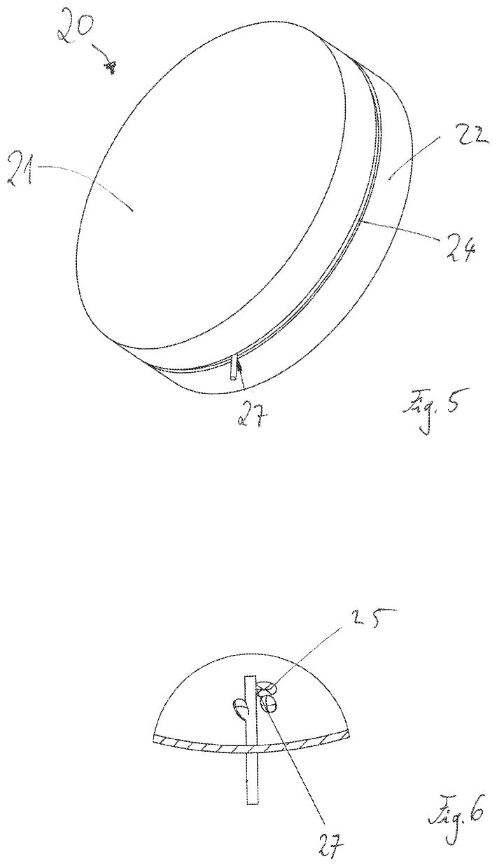

FIGS. 5 and 6 show another schematically drawn embodiment of a roasting drum 20 with an alternative option for measuring the temperature of roast product. This roasting drum 20 has a circumferential slot 24 in its circumferential wall 22, through which a temperature sensor 27 projects into the roasting drum 20 and comes into contact with coffee beans or other roast product contained in the roasting drum 20 and thus registers its temperature.

The halves of the circumferential wall 21 on opposite sides of the slot 22 may for example be connected with each other via brackets, each of which forms an arch, through which the temperature sensor 27 can pass, when the roasting drum 20 is rotating.

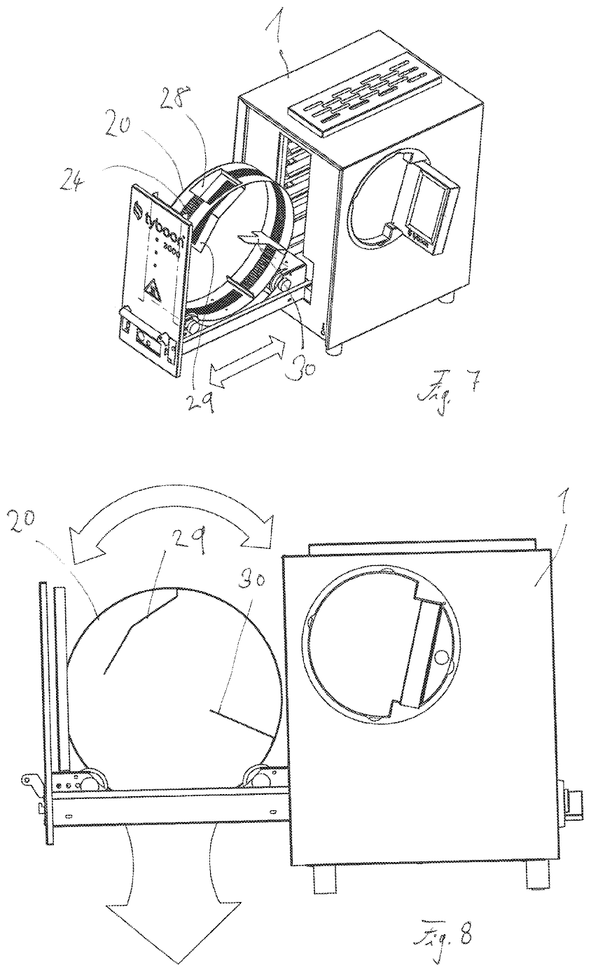

FIGS. 7 and 8 show a further embodiment of a radiation grill with a roasting drum 20. This embodiment differs from the embodiment of FIGS. 1 and 2 in essence only as regards the design of the roasting drum 20. The roasting drum 20 like the roasting drum 20 shown in FIG. 3 has slots 24 in its circumferential wall for measuring the temperature with an infrared sensor.

In difference to the roasting drum of FIG. 3 the roasting drum 20 of the embodiment shown in FIGS. 7 and 8 includes an outlet opening 28 in its circumferential wall for outputting roasted coffee beans or other roast product. The circumferential wall has a metal strip 29 attached to it, which is arranged radially inwards from the circumferential wall and which extends in circumferential direction from an edge of the outlet opening 28 to beyond the opposite edge thereof, for example by more than the width of the circumferential wall 20 to beyond the edge opposite the outlet opening 28. The metal strip 29 thus covers the outlet opening 28, so that a gap is formed between the circumferential wall 22 and the metal strip 29, which extends in circumferential direction and leads to the outlet opening 28. The metal strip 29 may be in contact with the two opposing sides of the roasting drum 20, i.e., it may be as wide as the circumferential wall of the roasting drum 20. But it is also possible that there is a gap on both longitudinal sides of the metal strip 29, as long as this is so small as to prevent any roast product from escaping through it.

It depends on the direction of rotation of the roasting drum 20, as to whether roast product gets into this gap and to the outlet opening. To output roast product the pull-out 2 is pulled out of the housing 1 and the direction of rotation of the roasting drum 20 is then reversed, so that then roast product gets through the gap between the metal strip 29 and the circumferential wall to the outlet opening 28 and then drops out of the outlet opening 28 so that it can be caught in a dish held below the pull-out 2.

When the roasting drum 20 is in the position shown in FIG. 6, roast product can be filled into the roasting drum through the outlet opening 28. In other words, the outlet opening 28 and the metal strip 29 therefore make it easier to both fill roast product into the roasting drum 20 and to remove roast product from the roasting drum 20.

Additionally, one or more mixing elements 30, for example metal sheets, may be attached to the circumferential wall, in order to improve intermixing of the roast product during roasting and thus during rotation of the roasting drum 20.

### LIST OF REFERENCE SYMBOLS

1 housing
2 pull-out
4 radiator
5 reflectors
6 perforated plate
7 feet
8 fan
20 roasting drum
21 side wall
22 circumferential wall
23 mounting
24 opening
25 coffee bean
26 temperature sensor
27 temperature sensor
28 outlet opening
29 metal strip
30 mixing element

What is claimed is:

1. A radiation grill, comprising:
a housing;
radiators arranged in the housing;
a roasting drum configured for receiving product to be roasted, said roasting drum rotatably arranged in the housing between the radiators;
a motor configured for rotating the roasting drum; and
a temperature sensor configured for measuring the temperature of product in the roasting drum;
wherein the roasting drum has one or more openings in a circumferential wall, said openings enabling the temperature sensor to measure the temperature of product in the roasting drum.

2. The radiation grill according to claim 1, wherein the opening is a circumferential slot extending in circumferential direction.

3. The radiation grill according to claim 1, wherein the circumferential wall of the roasting drum has a sequence of openings.

4. The radiation grill according to claim 3, wherein the temperature sensor is an infrared sensor configured to register infrared radiation of roast product exiting through the one or more openings.

5. The radiation grill according to claim 4, wherein the temperature sensor projects into the slot.

6. The radiation grill according to claim 5, wherein the roasting drum comprises two glass plates, which are connected via the circumferential wall.

7. The radiation grill according to claim 6, wherein an outlet opening is arranged in the circumferential wall, said outlet opening being configured for removing roasted product from the roasting drum.

8. The radiation grill according to claim 7, wherein a metal strip is attached to the circumferential wall, said metal strip being arranged radially inwards from the circumferential wall and extending in circumferential direction from an edge of the outlet opening to beyond the opposite edge thereof.

9. The radiation grill according to claim 8, wherein the metal strip extends in circumferential direction beyond the edge of the outlet opening, to which it is not attached, over a length which is greater than the width of the circumferential wall.

10. The radiation grill according to claim 9, wherein there is a gap between the metal strip and the circumferential wall in order to guide roast product to the outlet opening.

11. The radiation grill according to claim 1, wherein a metal sheet for mixing projects inwards, starting from the circumferential wall of the roasting drum.
